(19) United States
(12) Patent Application Publication
(10) Pub. No.: US 2003/0185955 A1
(43) Pub. Date: Oct. 2, 2003

(54) Nutritious salt formulations of plant origin and process for the preparation thereof

(76) Inventors: Pushpito K. Ghosh, Bhavnagar (IN); Muppala P. Reddy, Bhavnagar (IN); Jayant B. Pandya, Bhavnagar (IN); Jinalal S. Patolia, Bhavnagar (IN); Shambhubhai M. Vaghela, Bhavnagar (IN); Maheshkumar R. Gandhi, Bhavnagar (IN); Rahul J. Sanghvi, Bhavnagar (IN); Vaddiparty G.S. Kumar, Bhavnagar (IN); Mukesh T. Shah, Bhavnagar (IN)

Correspondence Address: NIXON & VANDERHYE P.C., 8th Floor, 1100 North Glebe Road, Arlington, VA, 22201, US

(21) Appl. No.: 10/112,057

(22) Filed: Apr. 1, 2002

(51) Int. Cl. A23L 1/22

(52) U.S. Cl. 426/534

(57) ABSTRACT

The invention describes the preparation of nutrient-rich salt from high salt-accumulating and edible oil-bearing salt tolerant plants in a way that allows simultaneous recovery of both salt and oil. The plants are routinely irrigated with seawater and occasionally with seawater enriched with salt bitterns and/or other types of wastes/by-products containing essential nutrients to raise the level of such nutrients in the plant.

### FILED OF THE INVENTION

The present invention relates to preparation of salt of plant origin. Specifically, the invention relates to preparation of nutritious salt formulations from edible salt tolerant oil-bearing plants in a manner that allows maximum utilization of the plant.

### BACKGROUND OF THE INVENTION

Salt is used as a food supplement to enhance the taste of food. Salt is one of the few commodities that is universally consumed by almost all sections of communities irrespective of socio-economic status. It is consumed approximately at the same level of 5-15 grams per day per person throughout the year. Hence salt is an attractive vehicle to introduce any nutrient supplement (M. G. Venkatesh Mannar, S. Jaipal and C. S. Pandya, Proceedings of Sixth International Congress, Seoul, 1989). For example, salt is iodized for the control of goitre and it is fortified with iron for control of anaemia. Salt is also a good vehicle for supply of other nutrients such as potassium, magnesium and calcium. Shuqing Wang in Patent No. CN 1271541 A, Nov. 1, 2000, titled “Multi-element low sodium nutritive salt”, disclose the preparation of low sodium nutritive salt by crystallising salt from saturated brine under vacuum. The salt is then mixed uniformly with salts such as KCl and MgSO₄.7H₂O, followed by mixing with KIO₃ and Na₂SeO₃ solutions, drying and finally mixing with active Ca and Zn lactate. The drawback of this process is that apart from the difficulty of mixing various constituents in a homogeneous solid mixture, salt is to be crystallised from hot saturated brine involving high energy consumption thereby increasing the cost of production. Moreover, such a salt is not natural in its constitution.

“The Heinz Handbook of Nutrition” by Benjamin T. Burton, published for H. J. Heinz Co., by McGraw Hill Book Co. Second Edition, page 132-133, describes the dietary need for potassium. R. N. Vohra et al. in pending PCT Patent Application No.PCT/IN02/00018, dated 31.1.2002 titled “A Process for Recovery of Low sodium Salt from Bittern”, discloses preparation of a mixture of sodium chloride and potassium chloride containing other nutrients such as magnesium and calcium by a natural process from sea/subsoil bittern. The main drawback of the process is that the salt does not contain essential micronutrients such as iodine, zinc, iron and manganese. Rock salts sold under the brand name “Real Salt” in the U. S. market, contains several essential micronutrients such as iron, manganese and iodine but which does not contain appreciable quantities of other essential nutrients such as potassium, calcium, magnesium and zinc. Rock salt is also available only in limited regions of the world.

Charnock, A. [(1988, December). Plants with a taste for salt. New Scientist, 3, pp. 41, 45] and Glenn, E. P., J. O'Leary, M. Watson, T. Thompson, and R. O. Kuehl [(1991) Salicornia bigelovii Torr.: An oilseed halophyte for seawater irrigation. Science, 251, 1065-67] describe cultivation of salt tolerant plants as a potential economic activity utilizing saline wasteland and seawater irrigation. Although it is described in the publications that halophytes such as Salicornia are especially suitable for production of nutritious edible oil with high level of polyunsaturates, deoiled poultry feed, and fodder that is suitable for cattle either as a mixed feed or which can be used alone after desalinating the fodder by washing, no mention is made with regards to recovery of salt from the plant.

M. P. Reddy, S. Sanish and E. R. R. Iyengar, Biol. Plant. 1993, 35, 547-553, report that halophytes possess the ability to concentrate salts of sodium, potassium, calcium, magnesium and to some extent micronutrients equaling or exceeding those of seawater in their leaves and stem when grown in saline conditions without adverse effects on growth and biomass production. However no attempt was made to produce salt for edible purposes from these plants. No attempt was also made to bias the composition of salts in the plant.

G. Naidoo and R. Rughunanan in J. Exp. Bot., 1990, 41,497-502, observe an increase in the concentration of inorganic ions (sodium, potassium, calcium, magnesium and chloride) in Sarcocornia natalensis expressed as percentage of dry weight with increase in salinity from 50 to 300 moles/m³. The increase in total inorganic ions was due primarily to Na (48%) and chloride (34%). However, no attempt was made to extract the salt.

T. J. Flowers and Y. Yeo in Aust. J. Plant Physiol. 1986, 13, 75-81, state that the dicotyledonous halophytes accumulate sodium and chloride ions to an extent of 30-50% by dry weight to maintain osmotic potential at higher salinity level. No attempt was made to recover this salt. S. Sanish (Ph. D. Thesis, Bhavnagar University, Bhavnagar, Gujarat, India, 1992) and S. Cherian, (Ph. D. Thesis, Bhavnagar University, Bhavnagar, Gujarat, India, 1996) have observed the accumulation of proteins, carbohydrates and 30-55% (of dry biomass) inorganic salts rich in sodium, potassium, calcium, magnesium, copper, iron, manganese and zinc in halophytes like Salicornia brachiata and Suaeda nudiflora when grown under saline conditions. However, they did not prepare salts from these plants for edible purposes.

Though it was known (T. F. Neals and P. J. Sharkey, Aust. J. Plant Physiol, 1981, 8, 165-179, S. Cherian et al, Indian J. Plant Physiol, 1999, 4, 266-270, S. Cherian and M. P. Reddy, Indian J. Plant Physiol, 2000, 5, 32-37 etc.) that certain halophytes accumulate reasonable amount of sodium, potassium, calcium, magnesium, copper, iron, manganese and zinc, the main focus of the work was to undertake mechanistic studies and none of the above attempted to prepare nutrient rich salt from such plants for edible purposes.

### OBJECTS OF THE INVENTION

The main object of the present invention is to provide a process for the preparation of salt from salt tolerant plants that accumulate high quantity of salt.

Another object of the present invention is to prepare a nutritious edible salt containing other essential minerals such as potassium, calcium, magnesium, copper, iron, manganese and zinc.

Yet another objective of the present invention is to enrich the plants with iodine by utilizing iodide-containing solid or liquid waste as co-irrigant or by using iodine-rich seaweeds as manure.

Another object is to promote such cultivation of salt tolerant plants in solar salt works where seawater and the waste bittern obtained as by-product of salt manufacture are used in combination for irrigation of the plants to enhance the nutrient value of the salt.

Yet another object of the invention is to recover both oil and salt from salt-tolerant oil-bearing plants.

### SUMMARY OF THE INVENTION

The present invention relates to development of a process for the preparation of nutrient-rich salt of plant origin, specifically salt tolerant oil-bearing plants that can be cultivated with seawater/salt bitterns and have a propensity to accumulate salt within their tissues. The invention allows nutrient-rich salt to be obtained naturally instead of through artificial mixing of nutrients as resorted to in the prior art. An additional aspect of the invention is that potassium-rich waste bittern of solar salt works can be utilised as nutrient supplement during irrigation to enhance the potassium content of the salt, besides increasing the proportions of other essential minerals like magnesium, copper, iron, iodine, manganese, and zinc. Another aspect is the utilization of by-product or waste iodide containing solids or liquids as co-irrigant to enhance iodine content in the plant. A further aspect of the invention is that the process of recovery of salt does not interfere with recovery of oil from the plant.

It is found that the halophytic plant species take up different metal salts by absorption when irrigated with sea or saline water and accumulate about 30-55% inorganic salts by dry weight in leaves and stem and the composition of salts can be adjusted utilizing waste bittern of salt industry as a co-irrigant. The salt can be obtained in crude or refined form and contains mainly sodium chloride besides essential minerals.

Accordingly the present invention provides a process for the preparation of nutrient rich salt from salt-tolerant plants comprising growing said salt tolerant plants on saline soils, irrigating with seawater and salt bitterns as co-irrigant; co-irrigating with seawater and desired amount of iodide; harvesting; washing with seawater; sun drying; separating seed from spikes, mixing the husk with the remaining biomass, charring in an open container; incinerating in a furnace to give crude herbal salt containing calcium, magnesium, potassium, sodium, chloride, zinc, iron, copper, manganese and other trace elements; dissolving the crude herbal salt in water; filtering; evaporating the solution to give fine white crystalline and free flowing refined salt.

In one embodiment of the invention, the free flowing refined salt is obtained by treating the dry biomass with hot water, decanting and solar evaporating the leachate to recover salt rich in both inorganic and organic nutrients.

In another embodiment of the invention, salt tolerant plants are selected from plants which can be cultivated on saline soils with soil conductivity in the range of 15-140 dSm⁻¹ and irrigated with saline water including seawater of 2.5-4.0° Be′ and salt bitterns of 29-37° Be′.

In another embodiment of the invention, the salt tolerant plants from which salt is produced are preferably those that can accumulate up to 30-50% salt in their tissues.

In a further embodiment of the invention, the salt tolerant plants are of edible character and oil-bearing and are selected from Salicornia brachiata and Suaeda nudiflora.

In a further embodiment of the invention, waste salt bitterns rich in potassium and magnesium having density in the range of 29° Be′-37° Be′ is added into seawater as a co-irrigant in a ratio in the range of 0:1 to 1:1.

In another embodiment of the invention, 1 to 10 irrigations are carried out in addition to routine seawater irrigation over the cultivation period of 3-6 months to enrich the salt with potassium and other nutrients.

In yet another embodiment of the invention, iodide-containing liquid or solid waste is added to seawater in the range of 1-50 mM iodide to yield salt with iodine concentration in the range 10-100 ppm.

In another embodiment of the invention, iodine is added to the irrigant mixture in the form of manure comprising iodine-rich seaweed.

In a further embodiment of the invention, the charred biomass is incinerated in a furnace in the temperature range of 300-600° C. for 1-6 h to eliminate organic matter completely and sterilize the salt.

In another embodiment of the invention, the crude salt comprises 0.1-8.0% calcium, 0.2-7.0% magnesium, 0.5-10.0% potassium, 20-45% sodium, 20-60% chloride, 2-300 ppm zinc, 25-10000 ppm iron, 4-70 ppm copper, 5-800 ppm manganese.

In another embodiment of the invention, the refined salt obtained comprises 0.1-5% calcium, 0.2-5% magnesium, 0.5-15% potassium, 25-40% sodium, 40-60% chloride, 2-300 ppm zinc, 100-10000 ppm iron, 4-70 ppm copper; 50-800 ppm manganese: 10-100 ppm iodine.

In another embodiment of the invention, both the refined and crude salt obtained are free flowing.

In yet another embodiment of the invention, the crude salt is further refined to reduce the insolubles contained therein.

In another embodiment of the present invention, the pH of the seawater used for irrigating the plants was in the range of 7.3-8.5.

In another embodiment of the invention, the salt is obtained from the dried biomass the spikes of the plant yield oil containing seeds.

The invention also provides a process for preparing nutrient rich salt from salt-tolerant oil-yielding plants comprising growing such plants on 15-140 dSm⁻¹ saline soils, irrigating with 2.5-4.0° Be′ seawater and 29° Be′-37° Be′ bittern in the ratio of 1:0 to 1:1; harvesting; co-irrigating with seawater and desired amount of iodide in the form of solid or liquid waste containing iodine or iodine-rich seaweeds or other iodine-rich bio-sources as manure; washing with seawater; sun drying; separating seed from spikes, mixing husk with remaining biomass, charring in an open container; incinerating in a furnace at 300-600° C. to give crude herbal salt containing 0.1-8.0% calcium, 0.2-7.0% magnesium, 0.5-10.0% potassium, 20-45% sodium, 20-60% chloride, 2-300 ppm zinc, 25-10000 ppm iron, 4-70 ppm copper, 5-800 ppm manganese; dissolving crude herbal salt in distilled water; filtering; evaporating on hot water bath to give fine white crystalline and free flowing salt containing 0.1-5% calcium, 0.2-5% magnesium, 0.5-15% potassium, 25-40% sodium, 40-60% chloride, 2-300 ppm zinc, 10-10000 ppm iron, 4-70 ppm copper and 50-800 ppm manganese.

In another embodiment of the present invention, waste salt bitterns rich in K and Mg having density in the range of 29° Be′-37° Be′ is added into seawater as a co-irrigant up to a maximum extent of 50% of total volume.

In another embodiment of the present invention, iodide-containing salts were added into seawater as co-irrigant up to a maximum extent of 50 mM concentration of iodide to raise the iodine content of the plant.

In another embodiment of the present invention, the plant biomass is sun dried for a period of 4-7 days and the seeds were then removed manually from the spikes.

In another embodiment of the present invention, the total dry biomass after removal of seeds is ignited and charred in open container.

In another embodiment of the present invention, charred biomass is incinerated for 3-10 hours in a furnace at 300-600° C. to remove all organic matter and to sterilize the product.

In another embodiment of the present invention the crude salt is subjected to refinement in a conventional salt washery to purify the salt.

In another embodiment of the present invention, the crude salt was dissolved in water, the solution then filtered and evaporated to dryness to obtain white crystalline free flowing salt wherein all nutrients are retained.

In another embodiment of the present invention, the dry biomass is treated with hot water, the solution decanted and solar evaporated to recover salt.

### DETAILED DESCRIPTION OF THE INVENTION

Edible salt is normally prepared from seawater. Its production is based on solar evaporation. The other important sources are inland lakes, saline wells, rock salt (bedded deposits) and salt domes or diapiers as solid salt. Although there has been a trend towards refined edible salt, that is fortified with iodine for the prevention of goitre, and occasionally with iron for prevention of anaemia, other important nutrients are virtually absent. Crude salt compositions such as rock salt are popular because of the presence of many essential nutrients essential for the body, e.g., Fe, I, Mn, Cu, Zn. However, the proportions of some of the nutrients is small, e.g., 0.05-0.6% of K and 1-5 ppm Zn. It has been found in the course of this invention that substantially higher amounts of such essential minerals accumulate in tissues of salt tolerant plants in addition to NaCl.

Moreover, plants such as Salicornia and Sueda are edible and even available in markets as fresh vegetable in several countries. On the other hand, when the plants are dried, oil can be recovered from the seeds but the remaining dry biomass is normally unutilized. The invention rests on the realisation that this biomass is a rich source of accumulated salt and minerals, and can be converted into nutrient-rich salt if the organic matter and insolubles can be eliminated without loss of salt and mineral nutrients. Another aspect of the invention is that when such plants are cultivated in the vicinity of solar salt works, the waste bitterns of the salt industry can be utilized as irrigant in combination with seawater to enhance the nutrient value of the salt since the bitterns are substantially more concentrated in potassium, magnesium, and micronutrients than the seawater alone. If desired, iodide-containing solid or liquid waste or iodine-containing bioresources such as certain seaweeds are utilized to raise the iodine content of the plants.

Halophytes are those which can thrive on seawater/saline soils and produce biomass. Such plants are, therefore, ideally suited for saline wasteland cultivation. The incentive for such cultivation would be high if a better remuneration can be realized from the produce. Salicornia, for example, yields an edible oil that is highly rich in polyunsaturates but the low yield of oil (typically 200-500 kg from 1000-2500 kg of seed/hectare) may not make cultivation sufficiently attractive. To increase the attractiveness, it is essential to realize a second product from the produce that is also potentially marketable. Since 10-20 tons of dry biomass of Salicornia can be produced per hectare of cultivation, and since 40-50% of this biomass comprises salt, it is possible to obtain 4-10 tons of nutrient rich salt from the biomass. Being nutrient-rich, the salt is sufficiently more valuable than ordinary solar salt and is an attractive additional source of income in addition to the income from the oil.

Salicornia brachiata, an annual erect branched herb, belonging to the family Chenopodiaceae was selected in view of the high accumulation (45% of dry weight) of salt, the known edible nature of the plant, the tolerance of the plant to seawater irrigation and even to bittern, and the high biomass (10-20 tons dry weight per hectare) obtained in planned cultivation with elite germplasm.

Spikes obtained from elite germplasm of Salicornia brachiata were sown in about one acre saline soil in a coastal area inundated by seawater during high tides. Initially, the land was irrigated for one week with fresh water for easy germination and later with seawater for a period of six months. The fully-grown plants were then harvested by uprooting, the roots were removed, the plants were washed thoroughly with seawater, and sun dried. The dried biomass could be spontaneously burnt and thereafter it was subjected to further incineration in a muffle furnace at 425° C. The crude salt obtained was then dissolved in minimum quantity of water and filtered to remove insolubles. The solution was then subjected to forced or solar evaporation to recover the salt and nutrients completely.

Sodium and potassium were estimated by using Flame photometer, calcium and magnesium by the versinate method (Vogel, A text book of quantative inorganic analysis, 1978, The ELBS edition, London, and chloride by titrating against silver nitrate (Volhard, Modern method of plant analysis, 1956, edited by K. Peach and M. V. Tracey, Vol-1, 487, Springer verlag, Berlin, Edinburgh). For estimation of copper, iron, manganese and zinc in the plant the following was carried out: 2 ml of concentrated hydrochloric acid was added into a known quantity of crude salt obtained from the plant to dissolve micronutrients, the solution then evaporated on a hot water bath, dissolved in distilled water, filtered through Whatman filter paper (no. 44), the residue washed with hot distilled water till free from ions, the volume made up to required level, and finally analysed for copper, iron, manganese and zinc using AAS (Shimadzu Co. Ltd. model No. PR-5). A similar procedure was followed to estimate micronutrients in the purified salt.

The important innovative steps involved in the present invention are: (i) realization that salt can be recovered from salt tolerant plants in desired form, (ii) ensuring that the method of recovery is such that both oil and salt can be recovered from the dried biomass, (iii) developing a method to purify the salt while retaining its nutrition value, (iv) growing the plants in the vicinity of solar salt works and using waste bitterns of the salt works as co-irrigant together with seawater to enhance the content of potassium and other essential micronutrients in the salt, (v) supplementing the seawater with iodide-containing salts to raise the iodine content of the plant.

The following examples are given by way of illustration and should not be construed to limit the scope of the present invention.

### EXAMPLE 1

Salicornia brachiata plant was washed thoroughly with seawater to remove adhering particles of dirt. The plant, which weighed 37.2 Kg, was sun dried till a constant weight of 6.01 Kg. was obtained. The dried mass was charred in an open container by igniting with a matchstick and thereafter incinerated at 425° C. for 3 h to obtain 2.84 kg of crude salt. The crude salt was analysed for different elements and the following results were obtained: 22.21% sodium, 3.05% potassium, 1.05% calcium, 1.32% magnesium, 49.49% chloride, 2.53% sulphate, 104 ppm zinc, 1100 ppm iron, 43.5 ppm copper, and 214.1 ppm manganese.

### EXAMPLE 2

376 g of the crude salt of Example 1 was dissolved in 2 liters of distilled water and filtered. The filtrate was evaporated to dryness to yield 355 g of refined and free flowing salt of the following composition: 31.45% sodium, 2.77% potassium, 1.53% calcium, 1.69% magnesium, 56.47% chloride, 3.01% sulphate, 38.0 ppm zinc, 597.9 ppm iron, 14.5 ppm copper, and 58.3 ppm manganese.

### EXAMPLE 3

Salicornia brachiata grown in pots was irrigated with seawater for 3 months, and processed by the procedure of EXAMPLES 1 and 2 to give a refined salt with Potassium content of 2.72%.

### EXAMPLE 4

Salicornia brachiata grown in pots was irrigated with seawater for 3 months and during this period three irrigations were also given with a mixture of 31° Be′ bittern and seawater in the ratio of 1:3. The plants were processed as per the procedure of EXAMPLES 1 and 2 to give refined salt containing 4.19% potassium.

### EXAMPLE 5

Salicornia brachiata was cultivated in the field using seawater as irrigant. A single plant with dry weight of 427 g was harvested at maturity and seeds weighing 52 g were separated from the spikes. 15.76 g oil was recovered from the seeds through extraction with hexane. The remaining dry biomass weighing 361 g was processed as per the experimental procedure of Examples 1 and 2 to give 146 g of refined salt.

### EXAMPLE 6

Dry biomass of Salicornia brachiata was obtained as described in the procedure of Example 1. The dry biomass was directly extracted with hot water and salt could be recovered from the solution upon solar evaporation of the extract. The composition of the salt, which contained substantial quantities of useful organic compounds, was: 10.82% sodium, 1.53% potassiurm, 0.51% calcium, 1.14% magnesium, 26.34% chloride, 9.5% protein, 9% carbohydrate, 1.2% aniino acid, 5.8% Beta carotene.

### EXAMPLE 7

Suaeda nudiflora plant growing wildly was collected and processed as per the example of EXAMPLE 1 to give 1.43 kg of fresh biomass from which 0.28 kg of dry biomass was obtained. 0.13 kg of crude salt was obtained from the dry biomass as per the procedure of EXAMPLE 1. The crude salt contained 27.43% sodium, 3.21% potassium, 1.56% calcium, 2.32% magnesium, 4.1% sulphate, 43.43% chloride, 43 ppm zinc, 1152 ppm iron, 24.2 ppm copper, and 232 ppm manganese.

### EXAMPLE 8

Suaeda nudiflora grown in pots was irrigated and processed as per the procedure of EXAMPLE 4 and 250 g of fresh biomass was obtained which was sun dried to a constant dry weight (48.5 g). The dry biomass was treated as per the procedures of EXAMPLES 1 and 2 to yield 18.2 g of refined salt containing the following major cations: 27.52% sodium, 7.07% potassium, 0.8% calcium, and 0.5% magnesium.

### EXAMPLE 9

Salicornia brachiata grown in pots was irrigated with 0.6M sodium chloride supplemented with Hogland's nutrient solution. A final irrigation was given with the same solution but enriched with 50 mM potassium iodide a week before harvesting. The plants remained healthy and continued to grow, and their enrichment with iodine was confirmed through EDAX analysis of scanning electron micrographs of the plant tissues. The composition of the major ions in the plant as estimated by the EDAX analysis was: 24.38% sodium, 5.37% potassium 49.6% chloride and 8.6% iodide.

### EXAMPLE 10

150 g of crude salt was prepared from Salicornia brachiata as per the procedure of EXAMPLE 1. The salt was subjected to mechanical washing with saturated brine and the insolubles in the salt could be reduced from 12% to 8.3%.

The Main Advantages of this Invention Are:

1. Unlike common salt, the nutrient rich salt of plant origin is highly nutritious, being rich in important minerals such as potassium, iron, manganese, copper and zinc.

2. Up to 4-10 tons of nutrient rich salt can be obtained per hectare of cultivation and since large tracts of saline wasteland are available in the vicinity of solar salt works and other coastal areas, it may be possible to produce large quantities of such nutrient-rich salt.

3. Production of such nutrient rich salt from salt tolerant oil-bearing plants would make their cultivation more remunerative to the farmer since both edible oil and salt can be recovered.

4. The salt tolerant characteristics of the plants selected in the present invention make the plants amenable to irrigation with not only plain seawater but with bittern-supplemented seawater that greatly improves the potassium content of the salt besides increasing the levels of other micronutrients as well.

5. The salt would appeal to strict vegetarians since it is derived from a vegetable source.

6. The crude and refined salts are naturally free flowing and do not require addition of additives such as silica and magnesium carbonate for this purpose.

7. The plants can be enriched in iodine by irrigation with seawater enriched with iodide salt preferably in waste sources or by adding iodine-rich manure such as Padina and Sargassum seaweeds to the soil.

We claim

1. A process for the preparation of nutrient rich salt from salt-tolerant plants comprising growing said salt tolerant plants on saline soils, irrigating with seawater and salt bitterns as co-irrigant; co-irrigating with seawater and desired amount of iodide; harvesting; washing with seawater; sun drying; separating seed from spikes, mixing the husk with the remaining biomass, charring in an open container; incinerating in a furnace to give crude herbal salt; dissolving the crude herbal salt in water; filtering; evaporating the solution to give fine white crystalline and free flowing refined salt.

2. A process as claimed in claim 1 wherein the free flowing refined salt is obtained by treating the dry biomass with hot water, decanting and solar evaporating the leachate to recover salt rich in both inorganic and organic nutrients.

3. A process as claimed in claim 1 wherein the salt tolerant plants are selected from plants which can be cultivated on saline soils with soil conductivity in the range of 15-140 dSm⁻¹ and irrigated with saline water including seawater of 2.5-4.0° Be′ and salt bitterns of 29-37° Be′.

4. A process as claimed in claim 1 wherein the salt tolerant plants from which salt is produced are those that accumulate up to 30-50% salt in their tissues.

5. A process as claimed in claim 1 wherein the salt tolerant plants are of edible character and oil-bearing and are selected from Salicornia brachiata and Suaeda nudiflora.

6. A process as claimed in claim 1 wherein waste salt bitterns rich in potassium and magnesium having density in the range of 29° Be′-37° Be′ is added into seawater as a co-irrigant in a ratio in the range of 0:1 to 1:1.

7. A process as claimed in claim 1 wherein the 1 to 10 irrigations are carried out in addition to routine seawater irrigation over the cultivation period of 3-6 months to enrich the salt with potassium and other nutrients.

8. A process as claimed in claim 1 wherein iodide-containing liquid or solid waste is added to seawater in the range of 1-50 mM iodide to yield salt with iodine concentration in the range 10-100 ppm.

9. A process as claimed in claim 1 wherein iodine is added to the irrigant mixture in the form of manure comprising iodine-rich seaweed.

10. A process as claimed in claim 1 wherein the charred biomass is incinerated in a furnace in the temperature range of 300-600° C. for 1-6 h to eliminate organic matter completely and sterilize the salt.

11. A process as claimed in claim 1 wherein the crude herbal salt contains calcium, magnesium, potassium, sodium, chloride, zinc, iron, copper, manganese and other trace elements.

12. A process as claimed in claim 11 wherein the crude salt comprises 0.1-8.0% calcium, 0.2-7.0% magnesium, 0.5-10.0% potassium, 20-45% sodium, 20-60% chloride, 2-300 ppm zinc, 25-10000 ppm iron, 4-70 ppm copper, 5-800 ppm manganese.

13. A process as claimed in claim 1 wherein the refined salt obtained comprises 0.1-5% calcium, 0.2-5% magnesium, 0.5-15% potassium, 25-40% sodium, 40-60% chloride, 2-300 ppm zinc, 100-10000 ppm iron, 4-70 ppm copper; 50-800 ppm manganese: 10-100 ppm iodine.

14. A process as claimed in claim 1 wherein both the refined and crude salt obtained are free flowing.

15. A process as claimed in claim 1 wherein the crude salt is further refined to reduce the insolubles contained therein.

16. A process as claimed in claim 1 wherein the pH of the seawater used for irrigating the plants was in the range of 7.3-8.5.

17. A process as claimed in claim 1 wherein salt is obtained from the dried biomass, the spikes of the plant yield oil containing seeds.

18. A process for preparing nutrient rich salt from salt-tolerant oil-yielding plants comprising growing such plants on 15-140 dSm⁻¹ saline soils, irrigating with 2.5-4.0° Be′ seawater and 29° Be′-37° Be′ bittern in the ratio of 1:0 to 1:1; harvesting; co-irrigating with seawater and desired amount of iodide in the form of solid or liquid waste containing iodine or iodine-rich seaweeds or other iodine-rich bio-sources as manure; washing with seawater; sun drying; separating seed from spikes, mixing husk with remaining biomass, charring in an open container; incinerating in a furnace at 300-600° C. to give crude herbal salt containing 0.1-8.0% calcium, 0.2-7.0% magnesium, 0.5-10.0% potassium, 20-45% sodium, 20-60% chloride, 2-300 ppm zinc, 25-10000 ppm iron, 4-70 ppm copper, 5-800 ppm manganese; dissolving crude herbal salt in distilled water; filtering; evaporating on hot water bath to give fine white crystalline and free flowing salt containing 0.1-5% calcium, 0.2-5% magnesium, 0.5-15% potassium, 25-40% sodium, 40-60% chloride, 2-300 ppm zinc, 100-10000 ppm iron, 4-70 ppm copper and 50-800 ppm manganese.

19. A process as claimed in claim 18 wherein waste salt bitterns rich in K and Mg having density in the range of 29° Be′-37° Be′ is added into seawater as a co-irrigant up to a maximum extent of 50% of total volume.

20. A process as claimed in claim 18 wherein iodide-containing saks were added into seawater as co-irrigant up to a maximum extent of 50 mM concentration of iodide to raise the iodine content of the plant.

21. A process as claimed in claim 18 wherein the plant biomass is sun dried for a period of 4-7 days and the seeds were then removed manually from the spikes.

22. A process as claimed in claim 18 wherein the total dry biomass after removal of seeds is ignited and charred in open container.

23. A process as claimed in claim 18 wherein the charred biomass is incinerated for 3-10 hours in a furnace at 300-600° C. to remove all organic matter and to sterilize the product.

24. A process as claimed in claim 18 wherein the crude salt is subjected to refinement in a conventional salt washery to purify the salt.

25. A process as claimed in claim 18 wherein the crude salt is dissolved in water, the solution then filtered and evaporated to dryness to obtain white crystalline free flowing salt wherein all nutrients are retained.

26. A process as claimed in claim 18 wherein the dry biomass is treated with hot water, the solution decanted and solar evaporated to recover salt.
